(19) United States
(12) Patent Application Publication
(10) Pub. No.: US 2005/0144297 A1
(43) Pub. Date: Jun. 30, 2005

(54) Method and apparatus for providing content access controls to access the internet

(75) Inventors: Robert L. Dahlstrom, Jacksonville, FL (US); Kevin Bespolka, Vero Beach, FL (US); David DeWald, Jacksonville, FL (US)

Correspondence Address: FOLEY & LARDNER, 150 EAST GILMAN STREET, P.O. BOX 1497, MADISON, WI, 53701-1497, US

(73) Assignee: Kidsnet, Inc.

(21) Appl. No.: 10/748,689

(22) Filed: Dec. 30, 2003

(51) Int. Cl. G06F 15/16

(52) U.S. Cl. 709/229

(57) ABSTRACT

An Internet access control system is defined using a client-server architecture. The computer program installed on the client computer validates/identifies the user and user specific information is passed to the client computer. All user requests to access the Internet are intercepted by an application executing on the client computer. The URL extracted from the internet access request is sent to the Internet access control web server to determine if the URL is in a master list of previously evaluated websites. If the URL is found, the website ratings and subject matter categories are sent to the client computer for determination of whether or not the website contains information appropriate for the user attempting to access the Internet using web access settings defined by, for example, a parent or employer. If the URL is determined to be appropriate, the Internet access request is sent to the computer networking layer to which the request was originally routed; otherwise, the Internet access request is edited and is sent to the computer networking layer to which the request was originally routed for redirection of the transmission request.

### FIELD OF THE INVENTION

The present invention is related to control systems for accessing the Internet. More particularly, the present invention relates to a method and an apparatus for providing a database of pre-rated and pre-categorized websites and for allowing customized controls that allow, for example, a parent to determine a level of restriction independently for each child or an employer to determine a level of restriction independently for each employee.

### BACKGROUND OF THE INVENTION

The Internet is a wide area network that connects hundreds of thousands of computers and smaller sub-networks world-wide. Businesses, government bodies and entities, educational organizations, and even individuals publish information or data organized in the form of websites. A website may comprise multiple web pages that display a specific set of information and may contain links to other web pages with related or additional information. Some web pages include multiple web pages that are displayed in combination. Each web page is identified by a Uniform Resource Locator (URL) that includes the location or address of the computer that contains the resource to be accessed in addition to the location of the resource on that computer. The type of file or resource depends on the Internet application protocol. For example, the Hypertext Transfer Protocol (HTTP) describes a web page to be accessed with a web browser application. The file accessed may be a simple text file, an image file, an audio file, a video file, an executable, a common gateway interface application, a Java applet, or any other file supported by HTTP. The File Transfer Protocol (FTP) describes a resource comprising a file to be downloaded from the computer. Using the Internet, a user may access vast amounts of data some educational, some entertaining, and some informational. Not all of the data, however, should be accessed by all Internet users. Many websites contain what some users would consider violent, obscene, pornographic, crude, or discriminatory subject matter. Access to websites containing these types of material is particularly a problem for children who may be exposed to offensive material and for businesses whose employees may waste significant amounts of time viewing such websites. As a result, parents and employers may find it necessary to supervise their children's or employee's access to the Internet.

A variety of solutions have been proposed to control children's access to the Internet. For example, U.S. Pat. No. 5,987,611 discloses a system and methodology for managing Internet access. In this system, a centralized enforcement supervisor is located on the same network with the client computer. What is needed is a global solution wherein the supervisor is located on the Internet so that the same access rules are applied at any client computer regardless of the child's or employee's location. In this way, a parent can control a child's access using the same Internet access control system whether the child is accessing the Internet from home, from school, from the library, or from their grandparents house.

U.S. Pat. No. 6,571,256 discloses a method and apparatus for providing only pre-screened websites to a user. The pre-screened websites are stored on a server and are selected as acceptable by an authorized user. However, what is acceptable by the authorized user may not be acceptable by a parent for viewing by a younger child, but may be acceptable for viewing by an older child. What is needed are pre-evaluated websites which are rated based on the website content in a set of categories such that the parent can then independently select for each child the ratings in each of the categories that each child may view. In this way, the parent has control over the material that a child views on the Internet while not spending the significant amount of time to personally approve each website given that the Internet is populated with tens of millions of websites that may change. Similarly, some employees require access to websites that other employees do not. Thus, the employer should have independent control over the Internet access of each employee.

Thus, there is a need for an improved method and system of controlling access to the Internet that eliminates the need for the parent or the employer to personally supervise an individual's access to the Internet. Further, there is a need for an Internet access control system that has a fast response time, does not create unnecessary processing delays, and maintains security through the use of centrally maintained controls that avoid the possibility of corrupting or of negating the access controls. Further still, there is a need for a method and a system of allowing the parent or employer specific and detailed control over each individual's access to the Internet without the impossibility of requiring the parent or employer to specify each website the individual may view.

### SUMMARY OF THE INVENTION

An exemplary embodiment of the invention relates to an Internet access control system that uses a client-server architecture while advantageously performing all of the decision making logic at the client computer. The Internet access control system comprises sending user identification information to authenticate each user attempting to access the Internet from a client computer to an Internet access control web server to verify the account and to select the user web access settings previously defined for that user. The user identification information comprises a name and a password and may additionally comprise additional information, including but not limited to, biometrics, or insertion of an identification card such as a driver's license, credit card, library card, etc. The web access settings generally are defined by a master user who is typically a parent or an employer. The client computer receives the user web access settings from the Internet access control web server after the account is verified as an active and valid account. By sending the web access settings to the client computer each time a user logs into the Internet access control web server, the Internet access control system advantageously executes from any computer on which the system has been installed, insures that the most recent settings are always used for that user, and provides Web based administration of the user accounts. When the user attempts to access the Internet from any client computer on which the system has been installed, the program intercepts the request to access the Internet and applies the same web access control settings.

The URL is extracted from the request and sent to the Internet access control web server. Thus, there is no need to identify the user's browser or to identify the software that requests access to the Internet. The Internet access control web server attempts to locate the URL in a master list of pre-evaluated websites that have been rated and categorized based on the content of the website. If the URL is not found, a message stating this fact is sent to the client computer. If the URL is found, a message including URL ratings for the website is sent to the client computer. A “nested” lookup system is used such that if a subdirectory is found but the URL is not found, the rating for the subdirectory may be returned. For example, if the URL requested is www.xyz.com/directory/subdirectory/page.htm and there is no rating for the URL, but there is a rating for www.xyz.com/directory/subdirectory the rating for the subdirectory is used for all of the resources in that section of the website. The client computer compares the URL ratings to the web access settings for the user attempting to access the Internet. If the website is found to be appropriate for viewing based on the settings, the access request is sent to the computer network layering or protocol to which the original request was routed. If the website is found to be inappropriate, the access request is edited to redirect the Internet access request to an appropriate website located on the Internet access control web server, on the local network, or on the local computer, thus overriding the original request.

Another exemplary embodiment of the invention comprises a client computer and a Internet access control web server wherein the client is comprised of a user authentication interface module, a communication manager, and a logic module, and the Internet access control web server is comprised of a login manager and a lookup manager. The user authentication interface prompts a user for identification information. The communication manager sends the user identification information to the login manager located on the Internet access control web server. After the login manager verifies the account, the login manager selects the web access settings previously defined for that user by a master user who is typically a parent or an employer. The login manager sends the web access settings for the user to the communication manager. When the user attempts to access the Internet, the communication manager intercepts the request and extracts the URL for the requested website or Internet component that includes streaming audio or video, media downloads, executables, etc. The communication manager sends the URL to the lookup manager located on the Internet access control web server. The lookup manager attempts to locate the URL in a master list of pre-evaluated websites that have been rated and categorized based on the content of the website or URL. If the URL is not found, the lookup manager sends a message stating this fact to the client computer. If the URL is found, the lookup manager sends a message including URL ratings for the website to the communication manager. A “nested” lookup system may be used as related previously. The communication manager sends the settings to the logic module that compares the URL ratings to the web access settings for the user attempting to access the Internet. If the logic module finds the website to be appropriate, the logic module sends the access request to the computer networking layer or protocol to which the original request was routed. If the logic module finds the website to be inappropriate, the logic module edits the access request to redirect the website to an appropriate website located on the Internet access control web server, on the local network, or on the local computer before the request is sent to the computer networking layer or protocol to which the original request was routed.

Other principle features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is an overview diagram of the client-server architecture of an Internet access control system in accordance with an exemplary embodiment.

FIG. 2 is a flow diagram of an account manager in accordance with an exemplary embodiment.

FIG. 3 is a screen capture of an exemplary embodiment showing the information used to create a master user account.

FIG. 4 is a screen capture of an exemplary embodiment showing a link to an account manager.

FIG. 5 is a screen capture of an exemplary embodiment showing a first screen for the account manager where a child account can be added, edited, and deleted.

FIG. 6 is a screen capture of an exemplary embodiment showing a possible screen for defining identification information for the child account to access the Internet access control system.

FIG. 7 is a screen capture of an exemplary embodiment showing example “guides” who accompany the child while the child browses the Internet.

FIG. 8 is a screen capture of an exemplary embodiment showing the categories within which the controls can be customized for the child.

FIG. 9 is a screen capture of an exemplary embodiment showing optional web access settings that have been previously defined based on suitability for a particular age group.

FIG. 10 is a screen capture of an exemplary embodiment showing example language web access settings and context overrides based on the context of the material located on the website.

FIG. 11 is a screen capture of an exemplary embodiment showing example nudity and sex web access settings and context overrides based on the context of the material located on the website.

FIG. 12 is a screen capture of an exemplary embodiment showing example violence web access settings and context overrides based on the context of the material located on the website.

FIG. 13 is a screen capture of an exemplary embodiment showing example restrictive categories of subject matter that the master user may allow or disallow.

FIG. 14 is a screen capture of an exemplary embodiment showing a website manager for allowing or disallowing access by the user to specific websites overriding the ratings and categories for those websites.

FIG. 15 is a screen capture of an exemplary embodiment showing the process of defining the access for each user to the website.

FIGS. 16a, 16b, 16c, and 16d are flow diagrams of operations performed in accordance with an exemplary embodiment.

FIG. 17 is a screen capture of an exemplary embodiment showing a user authentication interface presented to the user before the user can access the Internet access control system.

FIG. 18 is a screen capture of an exemplary embodiment showing the user authentication interface presented to the user after the user has entered an incorrect password.

### DETAILED DESCRIPTION OF THE PREFERRED EMBODIMENTS

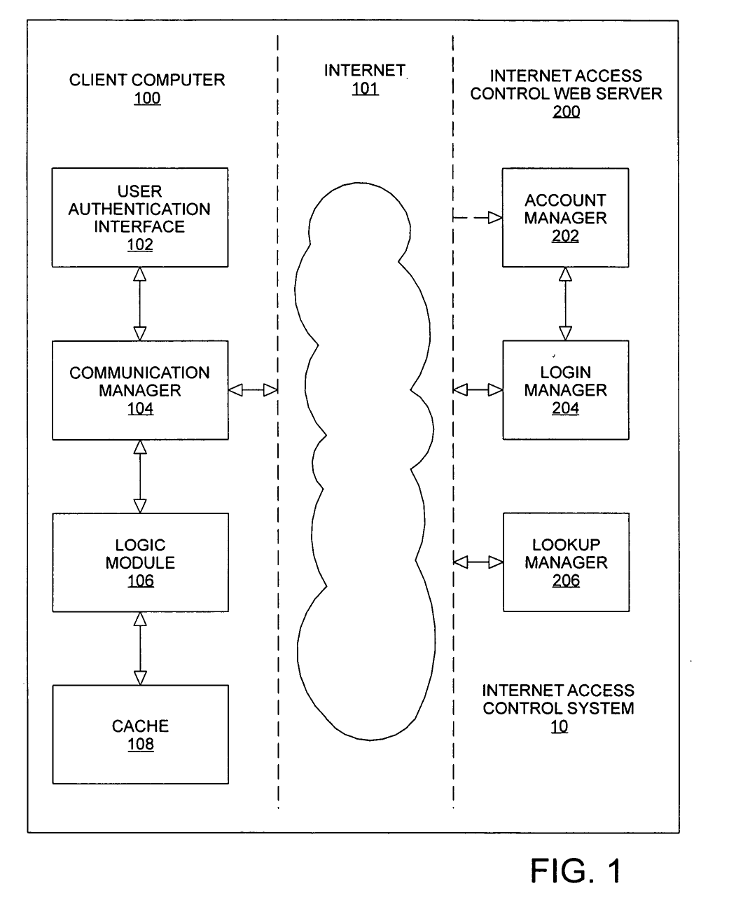

With reference to FIG. 1, the Internet content control system 10 is comprised of a client computer 100 and an Internet access control web server 200 that interact using the Internet 101 for the transmission of information between the respective computers. The functional processing of the client computer 100 includes, but is not limited to, a user authentication interface 102, a communication manager 104, a logic module 106, and a cache 108. The functional processing of the Internet access control web server includes, but is not limited to, an account manager 202, a login manager 204, and a lookup manager 206. The client computer 100 modules generally will be located on a single computer. The Internet access control web server 200 modules may be located on different computers that are connected to a common network such as a Local Area Network (LAN), Wide Area Network (WAN), or the Internet 101. In an exemplary embodiment, information flow between the client computer 100 and the Internet access control web server 200 is encrypted to maintain data security.

The user authentication interface module 102 is preferably implemented as a software application that prompts a user for identification information that includes, but is not limited to, a name and a password and transmits the information to the communication manager 104 or the login manager 204. The communication manager 104 is preferably implemented as a Virtual Device Driver (VxD) that interfaces directly with the computer communications layer and networking communications such as the Transmission Control Protocol/Internet Protocol (TCP/IP) stack or driver. The logic module 106 is preferably implemented as a dynamic link library or executable code that determines whether or not access to the URL should be allowed. The cache 108 is preferably implemented as a text file or database that is stored in computer memory. The account manager 202 is preferably implemented as a web based application. The login manager 204 is preferably implemented as executable code that interacts with the account manager 202 and the communication manager 104. The lookup manager 206 is preferably implemented as executable code that interacts with the communication manager 104.

In an exemplary embodiment, the user authentication interface module 102 prompts a user for a name and a password. The user authentication interface module sends the name and the password to the communication manager 104. The communication manager 104 sends the name and the password to the login manager 204 located on the Internet access control web server 200 using network messaging protocols known in the art. After the login manager 204 verifies the account information, the login manager 204 selects the web access settings previously defined for that user, typically by a master user such as a parent or employer. The login manager 204 sends the web access settings to the communication manager 104. When the user attempts to access the Internet 101, the communication manager 104 intercepts the request and extracts the URL for the requested website. The communication manager 104 sends the URL to the logic module 106. The logic module 106 conducts a search to determine if the URL is in the cache 108 by comparing the URL to each URL stored in the cache 108 until a matching URL is found or the URL has been compared to each URL in the cache. If the URL is found in the cache 108, the logic module 106 determines if access to the URL was granted or not granted. If access to the URL was granted, the Internet access request is sent by the communication manager 104 to the computer networking layer or protocol to which the original request was routed. If access to the URL was not granted, the logic module 106 edits the access request to redirect the website requested to an appropriate website located on the Internet access control web server 200 before the request is sent. If the URL was not found in the cache 108, the communication manager 104 sends the URL to the lookup manager 206 located on the Internet access control web server 200. The lookup manager 206 attempts to locate the URL in a master list of pre-evaluated websites that have been rated and categorized based on the content of the website. If the URL is not found, the lookup manager 206 sends a message stating this fact to the communication manager 104. If the URL is found, the lookup manager 206 sends a message including URL ratings to the communication manager 104. The communication manager 104 sends the ratings to the logic module 106. The logic module 106 compares the URL ratings to the web access settings for the user attempting to access the Internet 101. If the logic module 106 determines the website to be appropriate, the communication manager 104 sends the access request to the computer networking layer or protocol to which the original request was routed. If the logic module 106 finds the website not to be appropriate, the logic module 106 edits the access request to redirect the website requested to a user appropriate website located on the Internet access control web server 200, on the local network, or on the client computer 100 before the request is sent. The URL is added to the cache 108. Added to the cache 108 with the URL is a status parameter that identifies whether or not access to the URL was granted or not granted. The cache 108 is cleared when the user logs out from the Internet access control system or is logged out by the Internet access control system based on inactivity for a specified period of time. Clearing the cache 108 prevents the next user from viewing an inappropriate website that may have been appropriate for the previous user and prevents allowing access to a website when the web access settings have been changed and the access may no longer be appropriate. If the URL resource was requested using a browser (.e.g. Netscape®, Microsoft® Internet Explorer™), the browser cache is also cleared. The functionality of the Internet access control system will be discussed in more detail below.

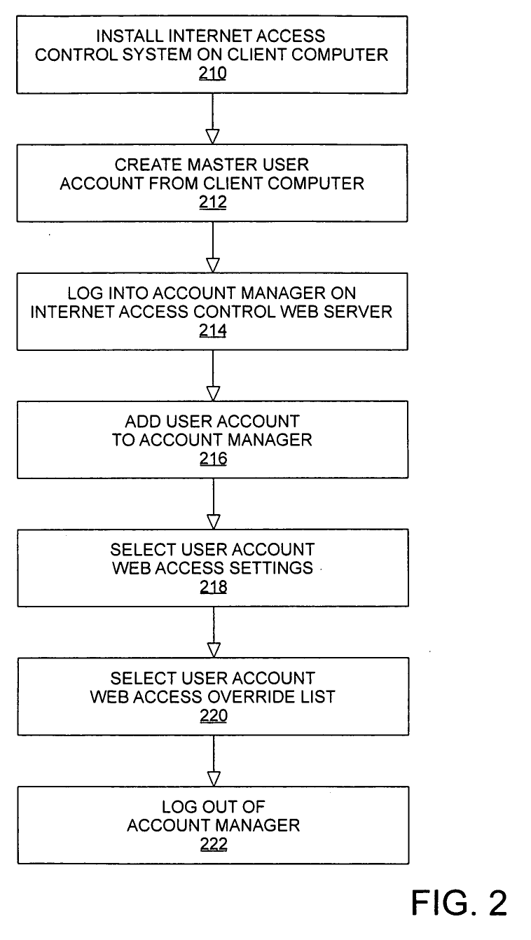

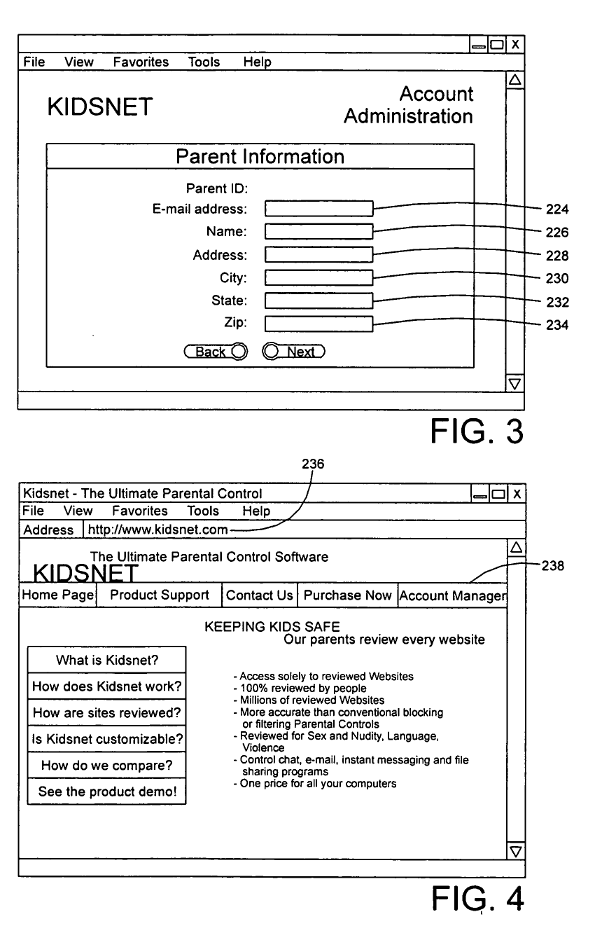

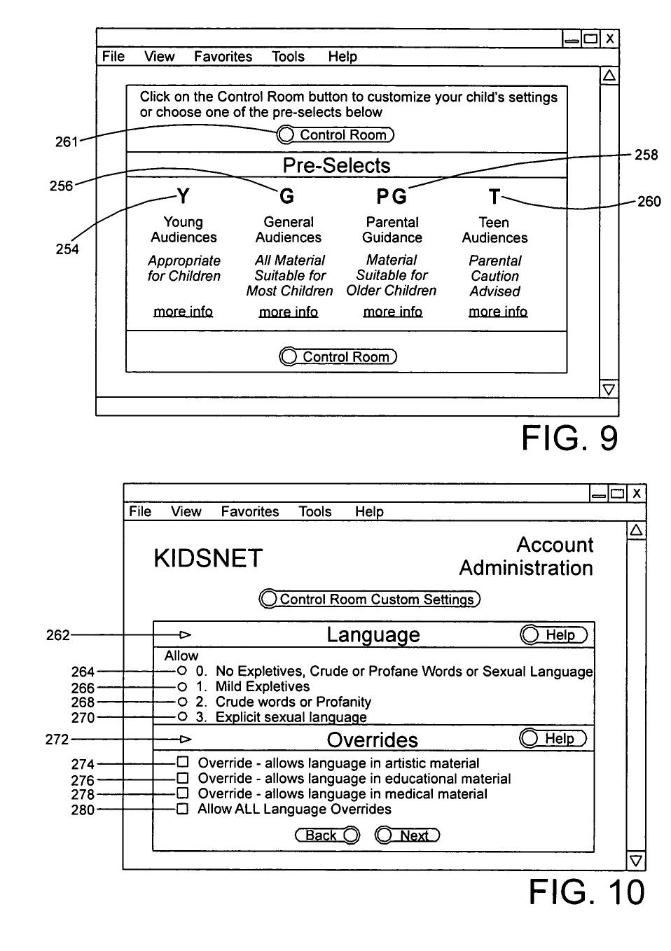

With reference to FIGS. 2-17, the account manager 202 will be described below. FIG. 2 shows a flow diagram of processing operations performed by the account manager 202. Additional, fewer, or different operations may be performed, depending on the embodiment without deviating from the spirit of the invention. The account manager 202 configures the account either before or after the Internet access control software is installed on the client computer 100 as shown at operation 210. As part of the installation process, the consumer enters a master user identifier (Parent ID) and a master user password and creates a master user account as shown at operation 212. The master user account information is communicated to the account manager 202 where it is stored. Thus, once a master user account is created, the Internet access control software can be installed on multiple computers using the same master user account information stored on the account manager 202 and no additional action is required (i.e. the master user account is configured only once). FIG. 3 shows example parameters used to create the master user account. These parameters include, but are not limited to, a unique master user identifier, contact information such as an e-mail address 224, a name 226, an address 228, a city 230, a state 232, and a zip code 234. Subsequent to the installation of the Internet access control software and the creation of the user account, the master user logs into the account manager 202 that is located on the Internet access control web server. The operation 214 of logging into the account manager 202 requires accessing the Internet 101 to connect to the Internet access control web server 200. The Internet access may be achieved by opening a browser and entering the URL for the homepage 236 of the Internet access control web server and selecting the link 238 to the account manager 202 as shown in FIG. 4. Additional methods for accessing the account manager 202 exist including, but not limited to, using a link selectable from the Internet access control system software and using an automated system that connects automatically after successful installation of the Internet access control software on the client computer.

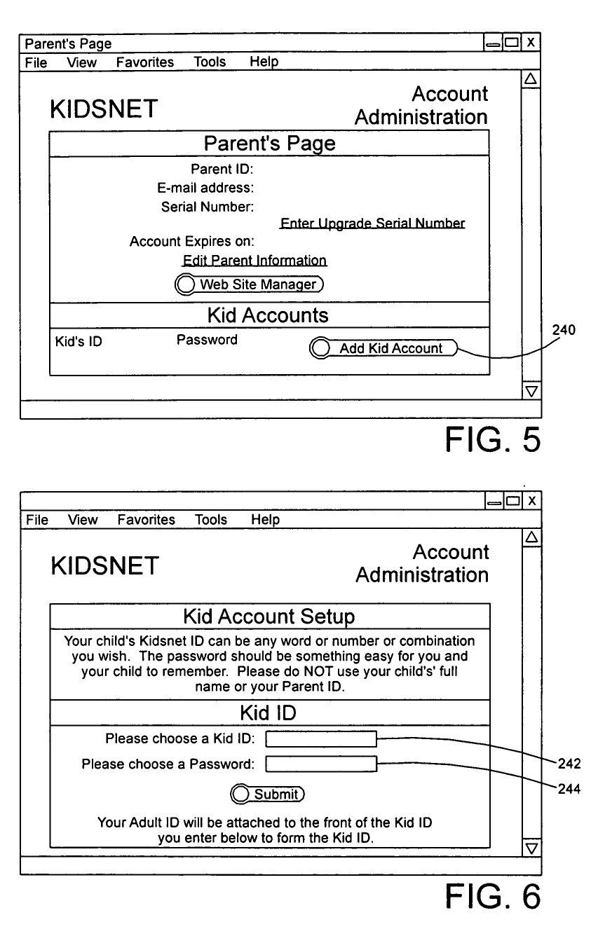

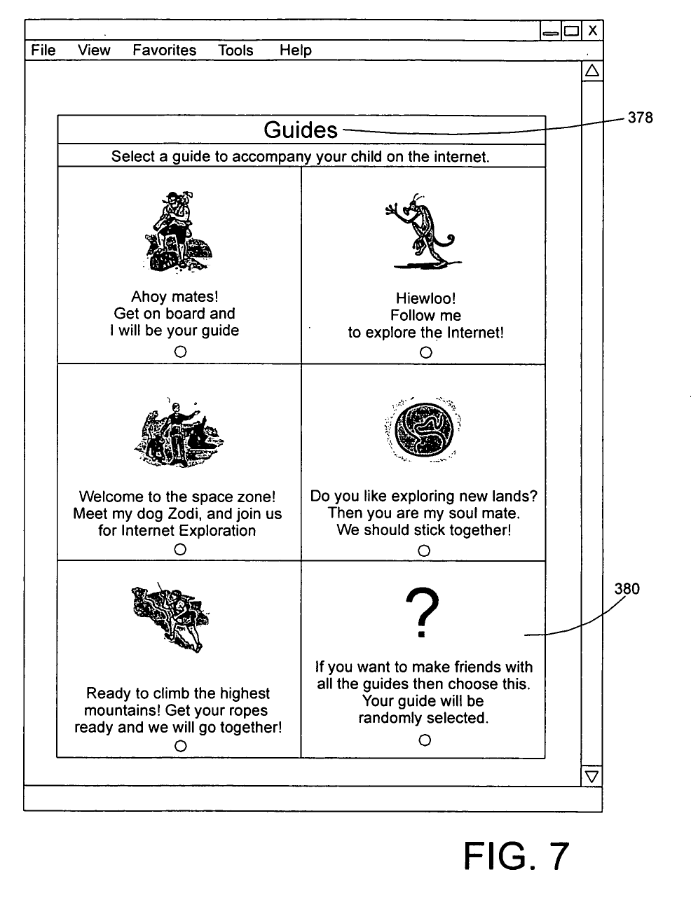

After logging into the account manager 202 at operation 214, the master user creates one or more user accounts as shown at operation 216. FIG. 5 illustrates an exemplary embodiment for a user account management window from which the parent may “Add a Kid Account” as shown at the user interface button 240. FIG. 6 shows a user account setup window indicating that the master user may first be prompted for a “Kid ID” or name 242 and a password 244 for the user account. In creating the user account at operation 216, the master user may additionally select a guide 378 to accompany the user when the user is a child as shown in FIG. 7. The master user may select a single guide to accompany the child or may allow the computer to randomly change the guide each time the child logs onto the Internet access control system 380.

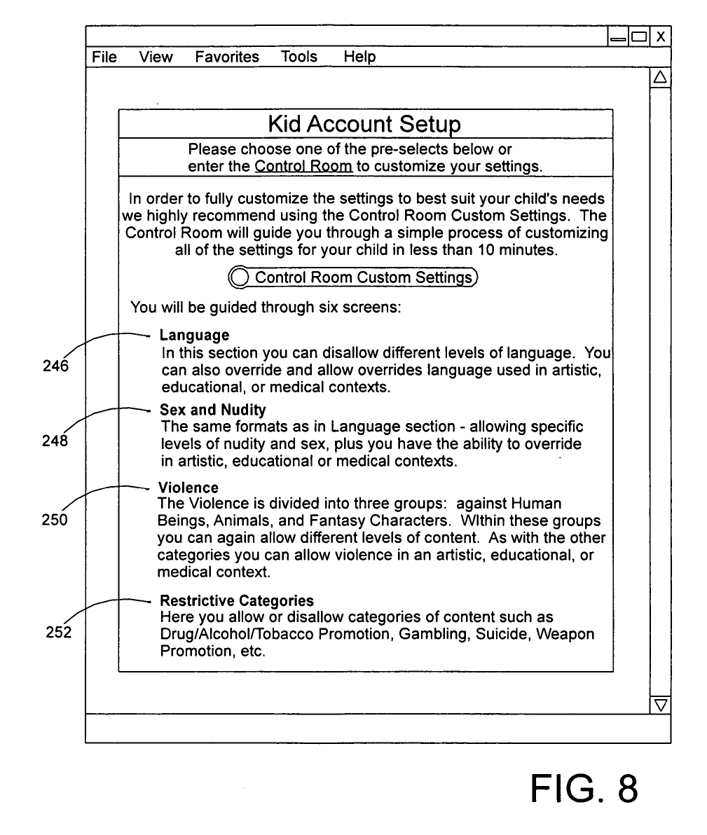

The master user selects the custom control settings that define the web access settings for the user account. The web access settings defined at operation 218 in FIG. 2 are subdivided into multiple categories for better specification of the subject matter to which access is controlled. In an exemplary embodiment as shown in FIG. 8, the categories within which specific control settings are defined include, but are not limited to, “Language” 246, “Sex and Nudity” 248, “Violence” 250, and “Restrictive Categories” 252. Optionally, to conserve time and to simplify the process of defining the web access settings for the user account, the master user may select a set of pre-selected settings based on, for example, the general age and maturity level of the user or the job requirements of an employee. In an exemplary embodiment, optional pre-selects may be categorized as “Y” 254 indicating subject matter appropriate for all children, “G” 256 indicating subject matter appropriate for most children, “PG” 258 indicating subject matter appropriate for older children, and “T” 260 indicating subject matter appropriate for teenagers and indicating Internet access caution is advised. By selecting the “Control Room” button 261, the master user instead may customize the web access settings for the user account.

FIG. 10 illustrates an exemplary embodiment for customizing “Language” 262 web access settings that include, but are not limited to, several categories of language restrictions, such as no expletives, crude or profane words or sexual language 264, mild expletives 266, crude words or profanity 268, and explicit sexual language 270. When choosing a level of language restriction, each selection is hierarchical such that a higher category includes the lower categories. For example, allowing the user to view or to hear crude words or profanity 268 also includes allowing the user to view or to hear mild expletives 266. The master user may optionally override the language restriction category when the language is used in a particular context. Context override categories 272 include, but are not limited to, artistic material 274, educational material 276, and medically related material 278. The master user who is a parent may, for example, allow a child to view sexual language in a single context such as in medically related material 278 or may allow the child to view sexual language in all of the context categories 280 or in any two context categories. This gives the parent flexibility in protecting a child from, for example, sexual language while not restricting the child from access to materials with educational value that may be useful in the child's development.

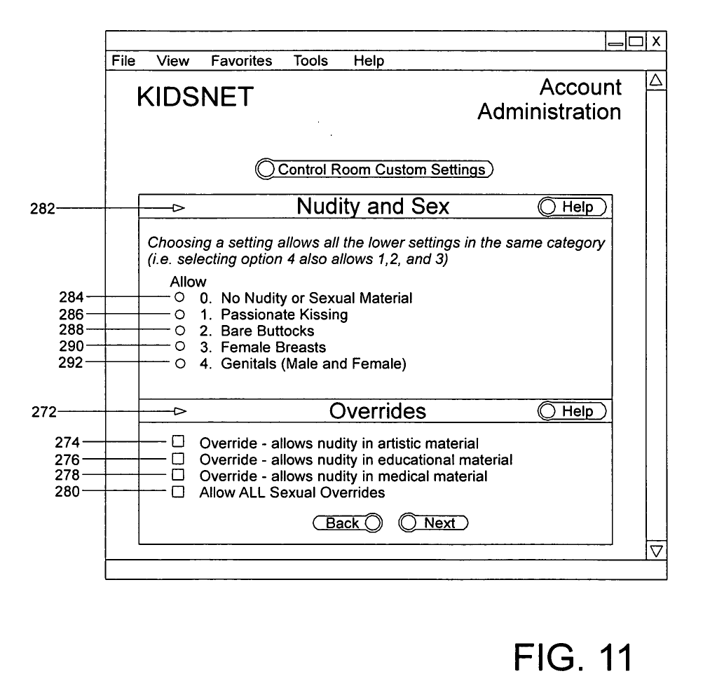

Similarly, FIG. 11 illustrates an exemplary embodiment for customizing “Nudity and Sex” 282 web access settings that include but are not limited to, several categories of nudity and sex restrictions, such as no nudity or sexual material 284, passionate kissing 286, bare buttocks 288, female breasts 290, and genitals (male and female) 292. Again, when choosing a level of nudity and sex restriction, each selection is hierarchical such that a higher category includes the lower categories. For example, allowing the user to view bare buttocks 288 also includes allowing the user to view passionate kissing 286. The master user may optionally override the nudity and sex restriction category when the material is used in a particular context. Context override categories 272 include, but are not limited to, artistic material 274, educational material 276, and medically related material 278. The master user who is a parent may, for example, allow a child to view female breasts in a single context such as in medically related material 278 or may allow the child to view female breasts in all of the context categories 280 or in any two context categories. This gives the parent flexibility in protecting a child from viewing, for example, male or female genitals while not restricting the child from access to materials with medical value that may be useful in the child's development.

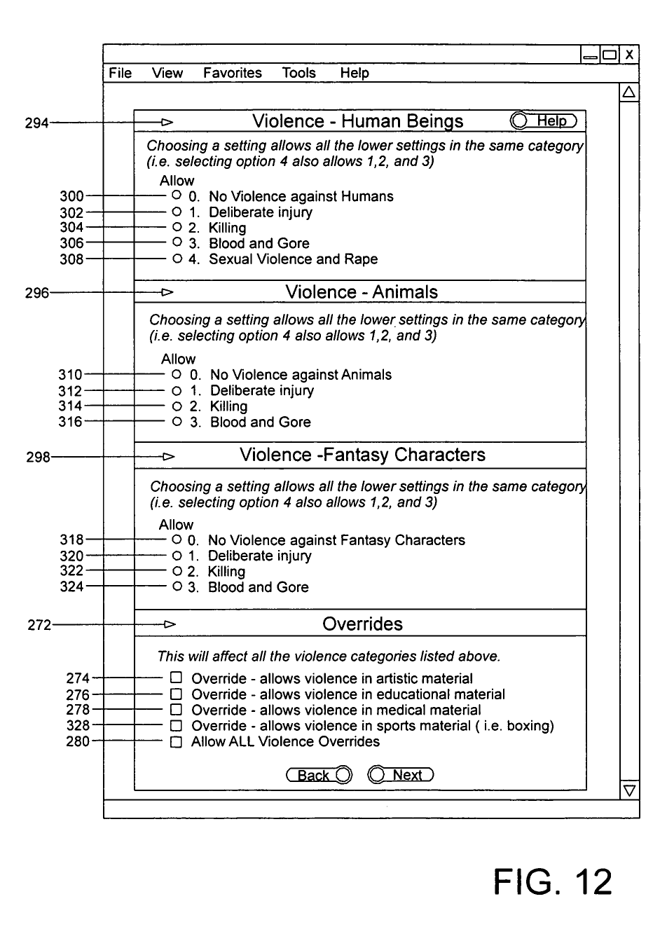

Similarly, FIG. 12 illustrates an exemplary embodiment for customizing “Violence” web access settings that include but are not limited to, several areas, such as violence involving human beings 294, violence involving animals 296, and violence involving fantasy characters 298. The custom web access settings for Violence involving Human Beings 294, includes, but is not limited to several areas, such as no violence against humans 300, deliberate injury 302, killing 304, blood and gore 306, and sexual violence and rape 308. The custom web access settings for Violence involving Animals 296, includes, but is not limited to several areas, such as no violence against animals 310, deliberate injury 312, killing 314, and blood and gore 316. The custom web access settings for Violence involving Fantasy Characters 298, includes, but is not limited to several areas, such as no violence against fantasy characters 318, deliberate injury 320, killing 322, and blood and gore 324. Again, when choosing a level of violence restriction, each selection is hierarchical such that a higher category includes the lower categories. For example, allowing the user to view killing of human beings 304 also includes allowing the user to view deliberate injury to human beings 302. The master user may optionally override all three of the violence restriction areas when the material is used in a particular context. Context override categories 272 include, but are not limited to, artistic material 274, educational material 276, medically related material 278, and sports material 328. The master user who is a parent may, for example, allow a child to view deliberate injury to human beings in a single context such as in sports related material 328 or may allow the child to view deliberate injury to human beings in all of the context categories 280 or in any two or in any three context categories. This gives the parent flexibility in protecting a child from viewing, for example, fights while not restricting the child from access to sports material such as boxing.

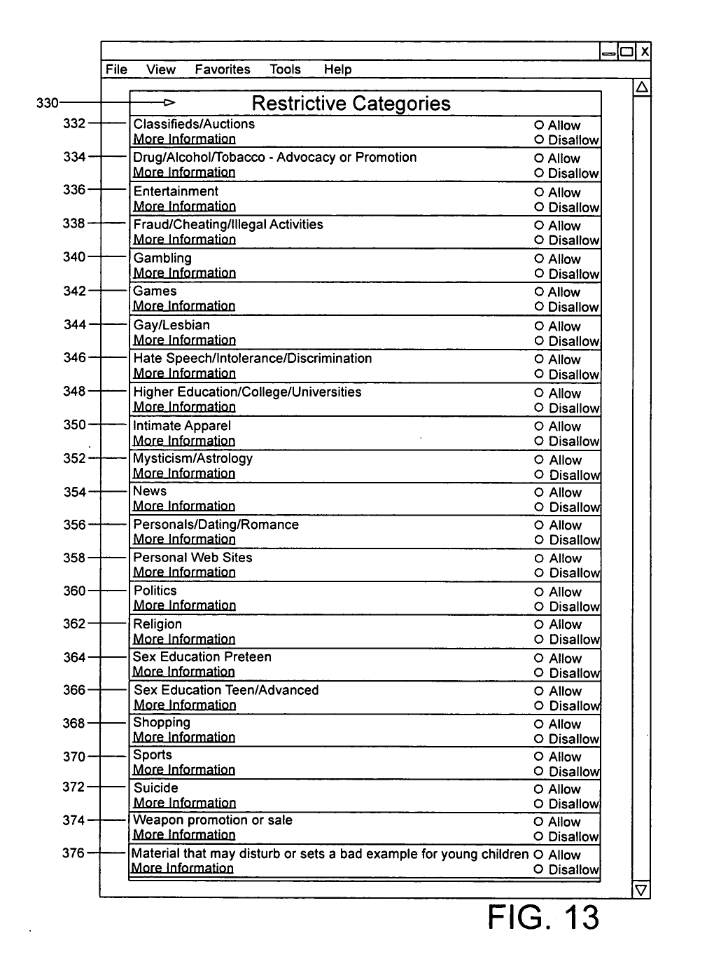

In addition to the custom web access settings “Language” 262, “Nudity and Sex” 282, “Violence—Human Beings 294, “Violence—Animals” 296, and “Violence—Fantasy Characters” 298, the master user may also restrict the user's access to websites containing other possibly inappropriate material. FIG. 13 shows additional “Restrictive Categories” 330 that include, but are not limited to, viewing classifieds/auctions 332, drug/alcohol/tobacco—advocacy or promotion 334, entertainment 336, fraud/cheating/illegal activities 338, gambling 340, games 342, gay/lesbian 344, hate speech/intolerance/discrimination 346, higher education/college/universities 348, intimate apparel 350, mysticism/astrology 352, news 354, personals/dating/romance 356, personal web sites 358, politics 360, religion 362, sex education preteen 364, sex education teen/advanced 366, shopping 368, sports 370, suicide 372, weapon promotion or sale 374, and material that may disturb or sets a bad example for young children 376. The master user may either allow or disallow the user from viewing material in each of these restrictive categories. For example, shopping 368 does not contain generally objectionable material, but unsupervised children may purchase products using on-line purchasing procedures without a parent's knowledge. As a result, the parent as the master user may want to restrict the child's ability to access websites that include shopping 368 to insure that the child is not purchasing products without the parent's permission. When using the Internet access control system 10 in a business environment, additional restrictive categories include, but are not limited to, adult sexual material, job search/careers, travel/tourism and vacation, motor vehicles, and stocks and investing.

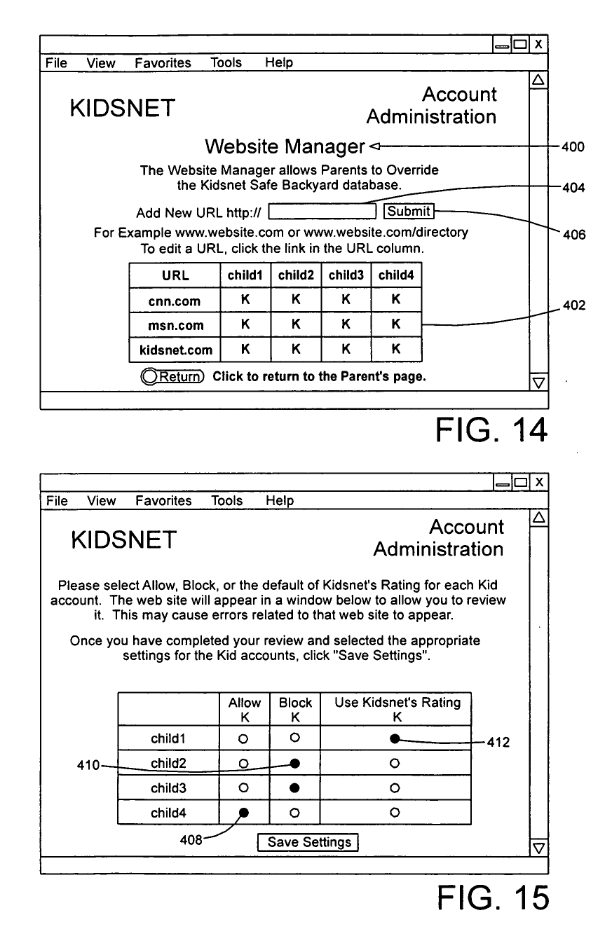

A master user may require additional more specific control over a user's access to the Internet 101. To accommodate this need, the account manager 202 additionally comprises a Website Manager 400 as shown in an exemplary embodiment in FIG. 14. The Website Manager 400 gathers information to be incorporated into a web access override list specified in FIG. 2 at operation 220. The Website Manager 400 displays a table that summarizes the access to specific websites for each user account created by the master user. The table 402 entries are color coded wherein a blue block “K” indicates that the website ratings and the custom web access settings for the user are used to determine if the user may view the website, a red block “K” indicates that the user may not view the website, and a green block “K” indicates that the user may view the website. The master user may enter additional websites to which the user may be granted access to or conversely denied access to by typing the URL for the website into the textbox 404 and selecting the submit button 406. For each user account, the master user selects either the radio button that allows the user access to the website 408, that blocks the user access to the website 410, or that determines whether the user may access the website based upon the URL ratings for the website in combination with the user account web access settings 412. Using the website manager, the master user may define a user web access override list for each user account that ignores the user web access settings and optionally either allows access to the URL or blocks access to the URL by that user account. After completing the process of defining the web access settings and the web access override list for each user account, the master user, at operation 222, logs out of the account manager 202. The Internet access control software is configured for use. The user account information is stored on the account manager 202. Thus, once a user account is created, the Internet access control software can be installed on multiple computers using the same user account information stored on the account manager 202 and no additional action is required by the master user (i.e. the user account is configured only once, but is accessible from multiple computers).

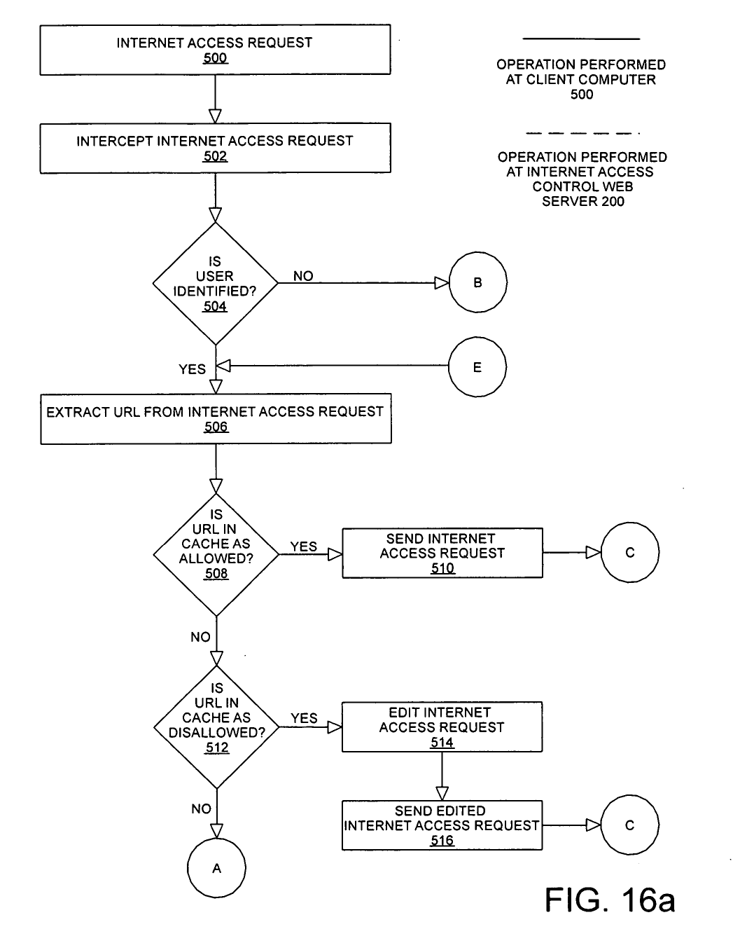

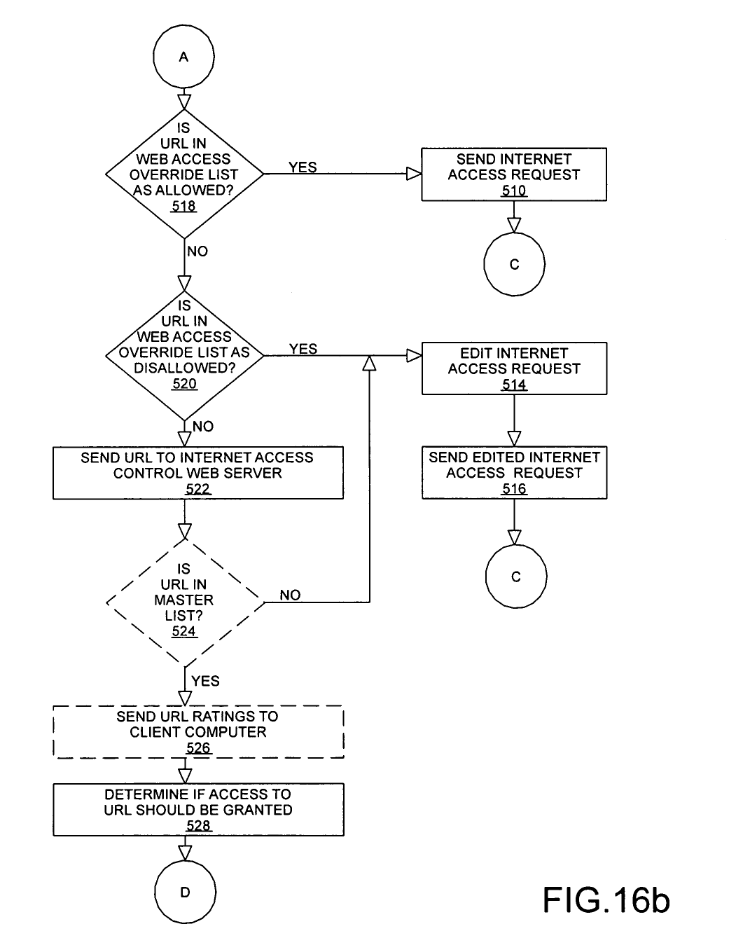

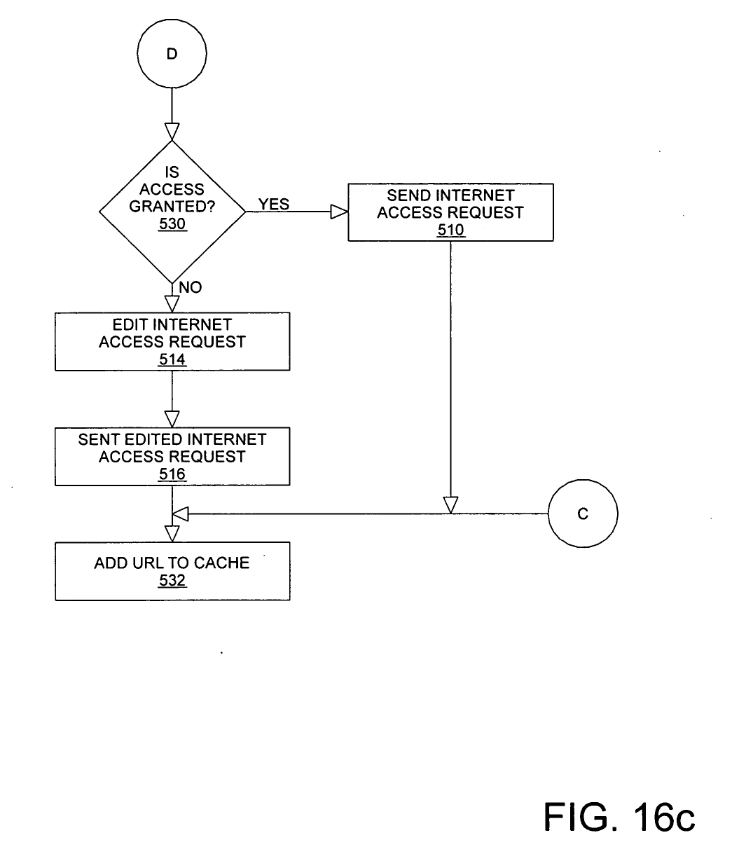

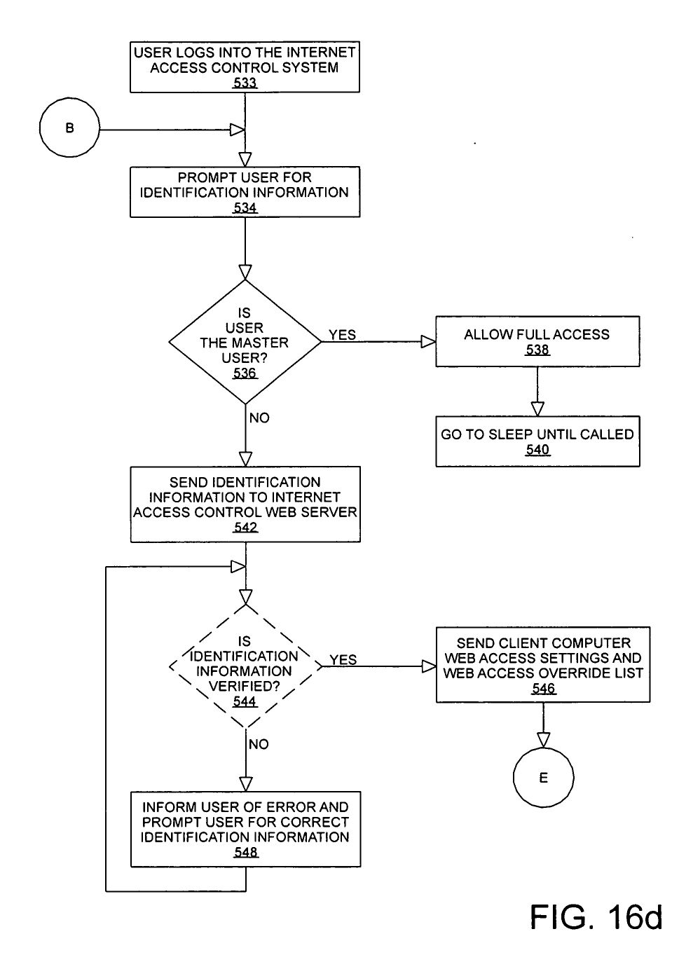

FIGS. 16a, 16b, 16c, and 16d show flow diagrams of an exemplary execution process for the Internet access control software. After configuring the user account(s), the Internet access control software execution is initiated whenever a user of the client computer 100 attempts to access a URL on the Internet 101 whether from a browser or any other application installed on the client computer 100. A communication message is transmitted from the application requesting the Internet access to the client computer 100 communication layer or driver (e.g., Winsock where a Microsoft® Windows operating system is installed) at operation 500. The communication manager 104, preferably implemented as a virtual device driver (VxD), continuously monitors for a request to access the networking layer for communicating with a network to which the computer is connected, typically the Internet 101, but possibly a LAN or a WAN.

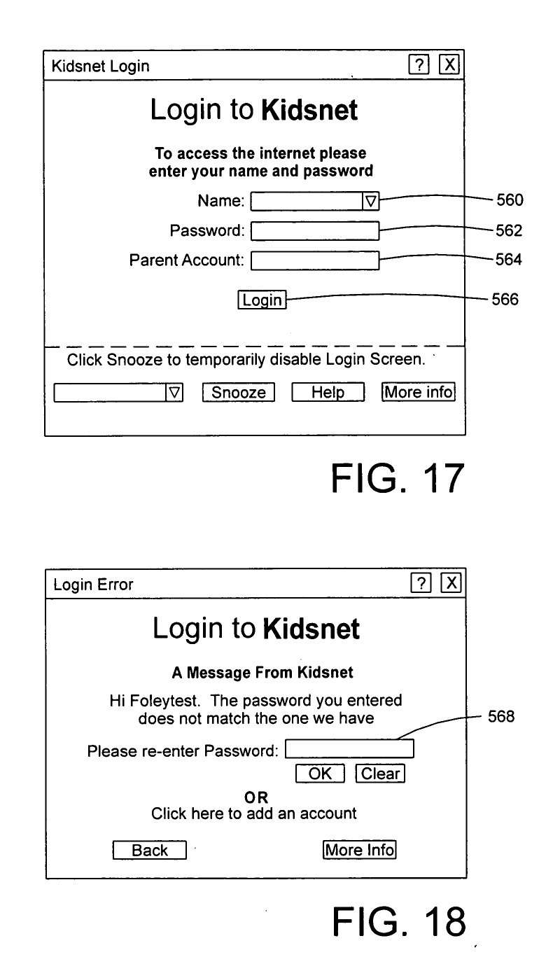

The communication manager 104 intercepts the request at operation 502. After intercepting the request to access the Internet 101, the communication manager 104, at operation 504, determines if the user has been identified by the Internet access control system 10. If the user has not been identified, the communication manager 104, at operation 534 sends a message to the user authentication interface module 102 to prompt the user to enter identification information comprising a name and a password as shown for an exemplary embodiment in FIG. 17. The user may type in the name assigned for their account or select the name from the drop down box shown at 560. The user enters the password assigned for their account at text box 562. The master user or “Parent Account” generally defaults to the master user identifier defined by the master user when the Internet access control system 10 was installed. If not, the user may enter the master user identifier in the text box at 564. After entering the required information, the user selects the “Login” button 566. The user authentication interface module 102, at operation 536, determines if the user is the master user. If the user is determined to be the master user, the user is allowed full, unrestricted access, as shown at operation 538, to the Internet 101. As shown at operation 540, the Internet access control system 10 effectively goes to sleep until “awakened” by a call from the communication manager 104 indicating that the master user has logged out from or been automatically logged out from the Internet access control system 10. Optionally, at operation 540, instead of going to sleep, the Internet access control system 10 may monitor the master user's Internet access activity by, for example, saving the URL requests in the logic module 106 or cache 108 or by sending URL requests to lookup manager 206. In this alternative embodiment, the Internet access control software provides additional services such as keyword resolution that allows a user to correctly access a URL even if a minor error occurs when the user types in the URL. For example, the Internet access control software recognizes that ww.kidsnet.com correctly corresponds to www.kidsnet.com. If the user is determined to be other than the master user, the user authentication interface module 102 sends the identification information to the communication manager 104.

The communication manager 104 encrypts the identification information and sends the information at operation 542 from the client computer 100 to the login manager 204 generally using the Internet 101 to which both the client computer 100 and the Internet access control web server 200 are connected as shown in FIG. 1. The login manager 204 decrypts the identification information and verifies that the account exists, that the password is correct, and that the account remains valid at operation 544. If the login manager 204 determines that the account information is invalid, does not exist, or the password is incorrect, the login manager 204 sends a message to the communication manager 104 to inform the user that an error has occurred and to prompt the user for the Login information. The communication manager 104, at operation 548, sends a message to the user authentication interface module 102 to prompt the user to enter the identification information again as shown in an exemplary embodiment in FIG. 18 if the password was determined to be incorrect. The user re-enters the password in text box 568. Similar windows may be displayed if the user incorrectly enters their name such that the account is not found or if the account is invalid or has expired. Thus, operations 544 and 548 are repeated until valid account information is entered.

After the account information is verified at the login manager 204, the login manager 204 requests that the account manager 202 send the user web access settings and the user web access override list to the login manager 204. The login manager 204, at operation 546, sends the web access settings and the web access override list to the communication manager 104. Alternatively, the user may login to the Internet access control system 10 before an Internet access request is transmitted by another application as indicated at operation 533. In either case, the user is identified at operation 504 after logging in to the Internet access control system 10 until the user logs out of the system 10 or is automatically logged out of the system, for example, due to inactivity for a period of time. Thus, subsequent Internet access requests proceed to operation 506 after the user has been initially identified.

If the user is not the master user, the Internet access request is sent to the logic module 106. The logic module 106 extracts the URL, at operation 506, from the Internet access request preferably as a string. The logic module 106 compares the extracted URL string to the cache 108 at operation 508. The cache 108 is a list of the URLs to which the user has previously requested access. Thus, the purpose of the cache 108 is to reduce the processing required in determining whether or not a user should be allowed access to a URL. The cache 108 is cleared whenever a user logs out of the Internet access control system 10. The cache 108 is cleared to address situations where the user web access settings or user web access override list has been changed such that access to a previously allowed URL is no longer allowed. Clearing the cache 108 also insures that a second user does not access URLs previously allowed to a first user without using the web access settings for the second user.

If the logic module 106 finds the URL in the cache 108, the logic module 106 determines if access to the URL was allowed, at operation 508, or disallowed, at operation 512. If access to the URL was allowed, the Internet access request is sent to the computer networking layer or protocol to which the request was originally routed for transmission of the request at operation 510. If access to the URL was not allowed, the logic module 106, at operation 514, edits the Internet access request to redirect the request to a user appropriate URL. The user appropriate URL may be an intelligent redirection based on the user's web access settings and the selected URL. For example, a user requests a site that is rated as “entertainment.” It may be replaced with a URL pointing to a site that states “Sorry you should be doing homework not looking at entertainment sites. Here is a list of homework help sites.” The edited Internet access request is sent to the computer networking layer or protocol to which the request was originally routed for transmission of the redirected request at operation 516. The user appropriate URL to which the request is redirected may be located on any web server, local network, or the computer itself and may be specified by the master user as part of the user account setup process performed by the account manager 202. In a preferred embodiment, the user appropriate URL is located on the Internet access control web server 200 and includes information concerning why access to the requested URL was denied for that user.

The logic module 106 determines if the URL is contained in the web access override list sent by the login manager 204 if the URL was not found in the cache 108. If the URL is in the web access override list, the logic module, at operation 518, determines if the URL is allowed. If the logic module 106 determines that the URL is allowed at operation 518, the Internet access request is sent to the computer networking layer or protocol to which the request was originally directed for transmission of the request at operation 510. If the logic module 106 determines that the URL instead is blocked and, thus, disallowed, the logic module 106, at operation 520, edits the Internet access request to remove the URL and to include a user appropriate URL at operation 514. The user appropriate URL may be an intelligent redirection based on the user's web access settings and the selected URL. For example, a user requests a site that is rated as “entertainment.” It may be replaced with a URL pointing to a site that states “Sorry you should be doing homework not looking at entertainment sites. Here is a list of homework help sites.” The redirected Internet access request is sent to the computer networking layer or protocol to which the request was originally routed for redirection of the transmission request at operation 516.

If the URL is not in the web access override list or is in the web access override list, but is defined to use the web access settings to determine whether or not the URL is appropriate, the URL is encrypted and sent by the communication manager 104 to the lookup manager 206 at operation 522. The lookup manager 206 determines if the URL is in a master list of websites at operation 524. The master list is a list of URLS that have been evaluated for content based on the ratings and categories discussed previously. Thus, in an exemplary embodiment, each URL is evaluated for its content relative to the language used, the nudity and sex displayed or discussed, and the violence against human beings, animals, and/or fantasy characters displayed or discussed on the website. The URL is rated using, for example, the levels shown previously in FIGS. 10-12. Additionally, each URL is further defined to either include or not include content in each of the restrictive categories shown in FIG. 13. Millions of websites have been rated using this methodology and the ratings and categories have been stored in the master list.

If the URL is not in the master list, a message is sent to the communication manager 104 indicating that the URL was not in the master list. This message is sent by the communication manager 104 to the logic module 106. The logic module 106, at operation 514, edits the Internet access request to route the request to a user appropriate URL that may display a message indicating that the URL is not in the master list and, thus, can not be viewed. The message may additionally indicate alternative URL's based on, for example, the user's Internet use history, the master user's preference, the content of the requested URL, or other variables. At operation 516, the edited Internet request is sent to the computer networking layer to which the request was originally routed for redirection of the transmission request. In a preferred embodiment, this website is located at the Internet access control web server 200. In an alternative embodiment, access to the URL may be granted if the URL was not found in the master list.

If the URL is found in the master list by the lookup Manager 306, the URL ratings that rate the URL in each of the categories as discussed previously are sent to the communication manager 104 at operation 526. The communication manager 104 sends the URL ratings to the logic module 106. At operation 528, the logic module 106 compares the URL ratings to the user web access settings to determine if the content of the website violates any of the user web access settings. For example, if the user web access settings allow the child to access websites that include profanity, but not those that include explicit sexual language and the URL includes explicit sexual language, access to the website will be denied as inappropriate. If the URL satisfies each of the user's web access settings and is, thus, appropriate for the user to view, the Internet access request is sent to the computer networking layer or protocol to which the request was originally routed for transmission of the request at operation 510. If the URL does not satisfy each of the user's web access settings and is, thus, inappropriate for the user to view, the logic module 106, at operation 514, edits the Internet access request to route the request to a user appropriate URL as related previously. The edited Internet access request is sent to the computer networking layer or protocol to which the request was originally routed for redirection of the transmission request at operation 516. The URL is added to the cache 108 at operation 532. Corresponding to the URL is an indication of whether access to the URL was allowed or disallowed.

It is understood that the invention is not confined to the particular embodiments set forth herein as illustrative, but embraces all such modifications, combinations, and permutations as come within the scope of the following claims. The description above focused on an exemplary embodiment of the invention designed to operate in an Internet connected environment on a computer system executing a Microsoft® Windows based operating system. The present invention, however, is not limited to a particular operating environment. Those skilled in the art will recognize that the system and methods of the present invention may be advantageously operated on different platforms using different operating systems including but not limited to the Macintosh® operating system or UNIX® based operating systems. Additionally, the functionality described may be implemented in a single executable or application or may be distributed among modules or managers that differ in number and distribution of functionality from those described herein without deviating from the spirit of the invention. Additionally, the order of execution of the functions may be changed without deviating from the spirit of the invention. Thus, the description of the exemplary embodiments is for purposes of illustration and not limitation.

1. A method of controlling access to the Internet, the method comprising:
sending identification information for a user from a client computer to an Internet access control web server;
receiving user web access settings from the Internet access control web server at the client computer, wherein the user web access settings comprise a level of access allowed for the user in at least one category of content;
intercepting an Internet access request initiated by an application used at the client computer by the user;
extracting a Uniform Resource Locator (URL) from the Internet access request at the client computer;
sending the URL to the Internet access control web server from the client computer;
receiving URL ratings from the Internet access control web server at the client computer, wherein the URL ratings comprise a rating level in at least one category of content;
comparing the URL ratings to the user web access settings at the client computer; and
determining if access to the URL should be granted.

2. The method of claim 1, further comprising sending the Internet access request to a client computer networking layer, if access is granted.

3. The method of claim 2, further comprising editing the Internet access request to remove the URL and to include a user appropriate URL and sending the edited Internet access request to the client computer networking layer, if access is not granted.

4. The method of claim 3, further comprising:
storing the URL in a cache at the client computer;
storing the URL in the cache as disallowed, if access is not granted;
storing the URL in the cache as allowed, if access is granted;
intercepting an additional Internet access request initiated by an application used at the client computer by the user;
extracting an additional URL from the additional Internet access request at the client computer;
comparing the additional URL to each URL in the cache until the additional URL matches a URL stored in the cache or until the additional URL has been compared to each URL in the cache;
sending the Internet access request to the client computer networking layer, if the additional URL matches a URL stored in the cache that was stored as allowed;
editing the additional Internet access request to remove the additional URL and to include the user appropriate URL, if the additional URL matches a URL stored in the cache that was stored as disallowed;
sending the edited additional Internet access request to the client computer networking layer, if the additional URL matches a URL stored in the cache that was stored as disallowed; and
clearing the cache when the user logs out from the Internet access control system at the client computer.

5. The method of claim 1, further comprising:
receiving a user web access override list from the Internet access control web server at the client computer, wherein the user web access override list comprises URLs to which the user is allowed access and URLS to which the user is not allowed access;
comparing the URL to the user web access override list at the client computer;
determining if access to the URL should be granted at the client computer;
sending the Internet access request to a client computer networking layer, if access is granted;
editing the Internet access request to remove the URL and to include a user appropriate URL, if access is not granted; and
sending the edited Internet access request to the client computer networking layer, if access is not granted.

6. The method of claim 6, further comprising:
storing the URL in a cache at the client computer;
storing the URL in the cache as disallowed, if access is not granted;
storing the URL in the cache as allowed, if access is granted;
intercepting an additional Internet access request initiated by an application used at the client computer by the user;
extracting an additional URL from the additional Internet access request at the client computer;
comparing the additional URL to each URL in the cache until the additional URL matches a URL stored in the cache or until the additional URL has been compared to each URL in the cache;
sending the Internet access request to the client computer networking layer, if the additional URL matches a URL stored in the cache that was stored as allowed;
editing the additional Internet access request to remove the additional URL and to include the user appropriate URL, if the additional URL matches a URL stored in the cache that was stored as disallowed;
sending the edited additional Internet access request to the client computer networking layer, if the additional URL matches a URL stored in the cache that was stored as disallowed; and
clearing the cache when the user logs out from the Internet access control system at the client computer.

7. The method of claim 1, wherein the user web access settings and the URL ratings further comprise context settings for at least one category of content.

8. The method of claim 7, wherein the context settings comprise a setting that the URL contains material of artistic value.

9. The method of claim 7, wherein the context settings comprise a setting that the URL contains material of educational value.

10. The method of claim 7, wherein the context settings comprise a setting that the URL contains material of medical value.

11. The method of claim 7, wherein the category of content comprises a language category.

12. The method of claim 11, wherein the language category of content comprises a plurality of selectable language content levels and a selectable context setting to optionally override the selected language content level.

13. The method of claim 7, wherein the category of content comprises a nudity and sex category.

14. The method of claim 13, wherein the nudity and sex category of content comprises a plurality of selectable nudity and sex content levels and a selectable context setting to optionally override the selected nudity and sex content level.

15. The method of claim 7, wherein the category of content comprises a violence category.

16. The method of claim 15, wherein the violence category of content comprises a plurality of selectable violence content levels and a selectable context setting to optionally override the selected violence content level.

17. The method of claim 15, wherein the violence category comprises a human being violence category.

18. The method of claim 15, wherein the violence category comprises an animal violence category.

19. The method of claim 15, wherein the violence category comprises a fantasy character violence category.

20. The method of claim 1, wherein the user web access settings and the URL ratings further comprise at least one restrictive category of content that may be either allowed or disallowed.

21. The method of claim 20, wherein the at least one restrictive category of content is auctions, drug advocacy, entertainment, illegal activities, gambling, games, Gay and Lesbian information, discriminatory speech, information concerning higher education, intimate apparel, information concerning mysticism, news, personal advertisements, personal websites, politics, religion, sex education, shopping, sports, information concerning suicide, weapon promotion, material that may disturb young children, material that may set a bad example for young children, adult sexual material, job search/careers, travel/tourism and vacation, motor vehicles, or stocks and investing.

22. A method of controlling access to the Internet, the method comprising:
receiving identification information for a user from a client computer at a Internet access control web server;
sending user web access settings from the Internet access control web server to the client computer, wherein the user web access settings comprise a level of access allowed for the user in at least one category of content;
receiving a Uniform Resource Locator (URL) from the client computer at the Internet access control web server, wherein the URL was extracted from an Internet access request at the client computer;
sending URL ratings from the Internet access control web server to the client computer, wherein the URL ratings comprise a rating level in at least one category of content that is capable of being compared to the user web access settings.

23. The method of claim 22, further comprising:
sending a user web access override list from the Internet access control web server to the client computer, wherein the user web access override list comprises URLs to which the user is allowed access and URLS to which the user is not allowed access.

24. The method of claim 22, wherein the user web access settings and the URL ratings further comprise context settings for at least one category of content.

25. The method of claim 24, wherein the context settings comprise a setting that the URL contains material of artistic value.

26. The method of claim 24, wherein the context settings comprise a setting that the URL contains material of educational value.

27. The method of claim 24, wherein the context settings comprise a setting that the URL contains material of medical value.

28. The method of claim 24, wherein the category of content comprises a language category.

29. The method of claim 28, wherein the language category of content comprises a plurality of selectable language content levels and a selectable context setting to optionally override the selected language content level.

30. The method of claim 24, wherein the category of content comprises a nudity and sex category.

31. The method of claim 30, wherein the nudity and sex category of content comprises a plurality of selectable nudity and sex content levels and a selectable context setting to optionally override the selected nudity and sex content level.

32. The method of claim 24, wherein the category of content comprises a violence category.

33. The method of claim 32, wherein the violence category of content comprises a plurality of selectable violence content levels and a selectable context setting to optionally override the selected violence content level.

34. The method of claim 32, wherein the violence category comprises a human being violence category.

35. The method of claim 32, wherein the violence category comprises an animal violence category.

36. The method of claim 32, wherein the violence category comprises a fantasy character violence category.

37. The method of claim 22, wherein the user web access settings and the URL ratings further comprise at least one restrictive category of content that may be either allowed or disallowed.

38. The method of claim 37, wherein the at least one restrictive category of content is auctions, drug advocacy, entertainment, illegal activities, gambling, games, Gay and Lesbian information, discriminatory speech, information concerning higher education, intimate apparel, information concerning mysticism, news, personal advertisements, personal websites, politics, religion, sex education, shopping, sports, information concerning suicide, weapon promotion, material that may disturb young children, material that may set a bad example for young children, adult sexual material, job search/careers, travel/tourism and vacation, motor vehicles, or stocks and investing.

39. A system for controlling access to the Internet, the system comprising:
a client comprising:
a user authentication interface that prompts a user for identification information;
a communication manager configured to:
send the identification information to an Internet access control web server,
receive user web access settings from the Internet access control web server, wherein the user web access settings comprise a level of access allowed for the user in at least one category of content,
intercept an Internet access request initiated by an application used at the client computer by the user;
send a Uniform Resource Locator (URL) extracted from the Internet access request to the Internet access control web server, and
receive URL ratings from the Internet access control web server, wherein the URL ratings comprise a rating level in at least one category of content; and
a logic module configured to:
compare the URL ratings to the user web access settings, and
determine if access to the URL should be granted; and
the Internet access control web server comprising:
a login manager configured to:
receive the identification information;
verify the identification information,
determine the user web access settings for the user that correspond to the identification information, and
send the user web access settings to the client; and
a lookup manager configured to:
receive the URL,
determine the URL ratings that correspond to the URL, and
send the URL ratings to the client.

40. The system of claim 39, wherein the communication manager is further configured to send the Internet access request to a client computer networking layer, if access is granted.

41. The system of claim 40, wherein the communication manager is further configured to:
edit the Internet access request to remove the URL and to include a user appropriate URL, if access is not granted; and
send the edited Internet access request to a client computer networking layer, if access is not granted.

42. The system of claim 41, wherein the client further comprises a cache configured to:
store the URL;
store the URL as disallowed, if access is not granted; and
store the URL as allowed, if access is granted.

43. The system of claim 42, wherein
the communication manager is further configured to:
intercept an additional Internet access request initiated by an application used at the client computer by the user;
send the additional Internet access request to the client computer networking layer, if an additional URL matches a URL stored in the cache as allowed; and
send an edited additional Internet access request to the client computer networking layer, if the additional URL matches a URL stored in the cache as disallowed; and
the logic module is further configured to:
extract the additional URL from the additional Internet access request at the client computer;
compare the additional URL to each URL in the cache until the additional URL matches a URL stored in the cache or until the additional URL has been compared to each URL in the cache;
edit the additional Internet access request to remove the additional URL and to include the user appropriate URL, if the additional URL matches a URL stored in the cache as disallowed; and
clear the cache when the user logs out from the system at the client computer.

44. The system of claim 39, wherein the communication manager is further configured to receive a user web access override list from the Internet access control web server, wherein the user web access override list comprises URLs to which the user is allowed access and URLs to which the user is not allowed access.

45. The system of claim 44, wherein
the logic module is further configured to:
compare the URL to the user web access override list;
determine if access to the URL should be granted;
edit the Internet access request to remove the URL and to include a user appropriate URL, if access is not granted; and
the communication manager is further configured to:
send the Internet access request to a client computer networking layer, if access is granted; and
send the edited Internet access request to the client computer networking layer, if access is not granted.

46. The system of claim 45, wherein the client further comprises a cache configured to:
store the URL;
store the URL as disallowed, if access is not granted; and
store the URL as allowed, if access is granted.

47. The system of claim 46, wherein
the communication manager is further configured to:
intercept an additional Internet access request initiated by an application used at the client computer by the user;
send the additional Internet access request to the client computer networking layer, if an additional URL matches a URL stored in the cache as allowed; and
send an edited additional Internet access request to the client computer networking layer, if the additional URL matches a URL stored in the cache as disallowed; and
the logic module is further configured to:
extract the additional URL from the additional Internet access request at the client computer;
compare the additional URL to each URL in the cache until the additional URL matches a URL stored in the cache or until the additional URL has been compared to each URL in the cache;
edit the additional Internet access request to remove the additional URL and to include the user appropriate URL, if the additional URL matches a URL stored in the cache as disallowed; and
clear the cache when the user logs out from the system at the client computer.

48. The system of claim 39, wherein the user web access settings and the URL ratings further comprise context settings for at least one category of content.

49. The system of claim 48, wherein the context settings comprise a setting that the URL contains material of artistic value.

50. The system of claim 48, wherein the context settings comprise a setting that the URL contains material of educational value.

51. The system of claim 48, wherein the context settings comprise a setting that the URL contains material of medical value.

52. The system of claim 48, wherein the category of content comprises a language category.

53. The system of claim 52, wherein the language category of content comprises a plurality of selectable language content levels and a selectable context setting to optionally override the selected language content level.

54. The system of claim 48, wherein the category of content comprises a nudity and sex category.

55. The system of claim 54, wherein the nudity and sex category of content comprises a plurality of selectable nudity and sex content levels and a selectable context setting to optionally override the selected nudity and sex content level.

56. The system of claim 48, wherein the category of content comprises a violence category.

57. The system of claim 56, wherein the violence category of content comprises a plurality of selectable violence content levels and a selectable context setting to optionally override the selected violence content level.

58. The system of claim 56, wherein the violence category comprises a human being violence category.

59. The system of claim 56, wherein the violence category comprises an animal violence category.

60. The system of claim 56, wherein the violence category comprises a fantasy character violence category.

61. The system of claim 39, wherein the user web access settings and the URL ratings further comprise at least one restrictive category of content that may be either allowed or disallowed.

62. The system of claim 61, wherein the at least one restrictive category of content is auctions, drug advocacy, entertainment, illegal activities, gambling, games, Gay and Lesbian information, discriminatory speech, information concerning higher education, intimate apparel, information concerning mysticism, news, personal advertisements, personal websites, politics, religion, sex education, shopping, sports, information concerning suicide, weapon promotion, material that may disturb young children, material that may set a bad example for young children, adult sexual material, job search/careers, travel/tourism and vacation, motor vehicles, or stocks and investing.

63. The system of claim 39, wherein the Internet access control web server further comprises an account manager configured to add a user account, to edit the user account, and to delete the user account.

64. The system of claim 63, wherein the user account comprises identification information.

65. The system of claim 64, wherein the user account further comprises web access settings comprising a level of access allowed for the user account in at least one category of content.

66. The system of claim 65, wherein the user account further comprises context settings for at least one category of content comprising overrides to the level of access allowed for the user account in the category of content.

67. The system of claim 66, wherein the user account further comprises at least one restrictive category of content that may be either allowed or disallowed for the user account.

68. The system of claim 67, wherein the user account further comprises a user web access override list, wherein the user web access override list comprises URLs to which the user account is allowed access and URLs to which the user account is not allowed access.

69. The system of claim 68, wherein the user account further comprises an appropriate URL for including in an Internet access request.

70. A computer program product for controlling access to the Internet comprising:
computer code configured to:
prompt a user for identification information;
send the identification information to an Internet access control web server,
receive user web access settings from the Internet access control web server, wherein the user web access settings comprise a level of access allowed for the user in at least one category of content,
intercept an Internet access request initiated by an application used at the client computer by the user;
send a Uniform Resource Locator (URL) extracted from the Internet access request to the Internet access control web server,
receive URL ratings from the Internet access control web server, wherein the URL ratings comprise a rating level in at least one category of content;
compare the URL ratings to the user web access settings, and
determine if access to the URL should be granted.

71. The computer program product of claim 70, wherein the computer code is further configured to send the Internet access request to a client computer networking layer, if access is granted.

72. The computer program product of claim 71, wherein the computer code is further configured to:
edit the Internet access request to remove the URL and to include a user appropriate URL, if access is not granted; and
send the edited Internet access request to the client computer networking layer, if access is not granted.

73. The computer program product of claim 72, wherein the computer code is further configured to:
store the URL in a cache at the client computer;
store the URL in the cache as disallowed, if access is not granted;
store the URL in the cache as allowed, if access is granted;
intercept an additional Internet access request initiated by an application used at the client computer by the user;
extract an additional URL from the additional Internet access request at the client computer;
compare the additional URL to each URL in the cache until the additional URL matches a URL stored in the cache or until the additional URL has been compared to each URL in the cache;
send the Internet access request to the client computer networking layer, if the additional URL matches a URL stored in the cache as allowed;
edit the additional Internet access request to remove the additional URL and to include the user appropriate URL, if the additional URL matches a URL stored in the cache as disallowed;
send the edited additional Internet access request to the client computer networking layer, if the additional URL matches a URL stored in the cache as disallowed; and
clear the cache when the user logs out from the computer program product.

74. The computer program product of claim 70, wherein the computer code is further configured to:
receive a user web access override list from the Internet access control web server at the client computer, wherein the user web access override list comprises URLs to which the user is allowed access and URLs to which the user is not allowed access;
compare the URL to the user web access override list at the client computer;
determine if access to the URL should be granted at the client computer;
send the Internet access request to a client computer networking layer, if access is granted;
edit the Internet access request to remove the URL and to include a user appropriate URL, if access is not granted; and
send the edited Internet access request to the client computer networking layer, if access is not granted.

75. The computer program product of claim 74, wherein the computer code is further configured to:
store the URL in a cache at the client computer;
store the URL in the cache as disallowed, if access is not granted;
store the URL in the cache as allowed, if access is granted;
intercept an additional Internet access request initiated by an application used at the client computer by the user;
extract an additional URL from the additional Internet access request at the client computer;
compare the additional URL to each URL in the cache until the additional URL matches a URL stored in the cache or until the additional URL has been compared to each URL in the cache;
send the Internet access request to the client computer networking layer, if the additional URL matches a URL stored in the cache as allowed;
edit the additional Internet access request to remove the additional URL and to include the user appropriate URL, if the additional URL matches a URL stored in the cache as disallowed;
send the edited additional Internet access request to the client computer networking layer, if the additional URL matches a URL stored in the cache as disallowed; and
clear the cache when the user logs out from the computer program product.

76. The computer program product of claim 70, wherein the user web access settings and the URL ratings further comprise context settings for at least one category of content.

77. The computer program product of claim 76, wherein the context settings comprise a setting that the URL contains material of artistic value.

78. The computer program product of claim 76, wherein the context settings comprise a setting that the URL contains material of educational value.

79. The computer program product of claim 76, wherein the context settings comprise a setting that the URL contains material of medical value.

80. The computer program product of claim 76, wherein the category of content comprises a language category.

81. The computer program product of claim 80, wherein the language category of content comprises a plurality of selectable language content levels and a selectable context setting to optionally override the selected language content level.

82. The computer program product of claim 76, wherein the category of content comprises a nudity and sex category.

83. The computer program product of claim 82, wherein the nudity and sex category of content comprises a plurality of selectable nudity and sex content levels and a selectable context setting to optionally override the selected nudity and sex content level.

84. The computer program product of claim 76, wherein the category of content comprises a violence category.

85. The computer program product of claim 84, wherein the violence category of content comprises a plurality of selectable violence content levels and a selectable context setting to optionally override the selected violence content level.

86. The computer program product of claim 84, wherein the violence category comprises a human being violence category.

87. The computer program product of claim 84, wherein the violence category comprises an animal violence category.

88. The computer program product of claim 84, wherein the violence category comprises a fantasy character violence category.

89. The computer program product of claim 70, wherein the user web access settings and the URL ratings further comprise at least one restrictive category of content that may be either allowed or disallowed.

90. The computer program product of claim 89, wherein the at least one restrictive category of content is auctions, drug advocacy, entertainment, illegal activities, gambling, games, Gay and Lesbian information, discriminatory speech, information concerning higher education, intimate apparel, information concerning mysticism, news, personal advertisements, personal websites, politics, religion, sex education, shopping, sports, information concerning suicide, weapon promotion, material that may disturb young children, material that may set a bad example for young children, adult sexual material, job search/careers, travel/tourism and vacation, motor vehicles, or stocks and investing.
